(19) United States
(12) Patent Application Publication
(10) Pub. No.: US 2009/0138306 A1
(43) Pub. Date: May 28, 2009

(54) FACILITY RISK ASSESSMENT SYSTEMS AND METHODS

(75) Inventors: Jonathan A. Coburn, Holly Springs, NC (US); Gregory B. Weddle, Zionsville, IN (US)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 12/238,186

(22) Filed: Sep. 25, 2008

Related U.S. Application Data
(60) Provisional application No. 60/976,315, filed on Sep. 28, 2007.

(51) Int. Cl. G06Q 10/00; G06N 5/02

(52) U.S. Cl. 705/7; 706/52

(57) ABSTRACT

A method for evaluating risk associated with a facility includes determining environmental requirements necessary for successful achievement of a function of the facility and determining consequences for failing to maintain the environmental requirements. The method further includes identifying facility systems necessary to maintain the environmental requirements and calculating risk based on the identified facility systems and the determined consequences. The method yet further includes storing the risk in a memory device and/or displaying the risk on a display screen.

### CROSS-REFERENCE TO RELATED APPLICATIONS

This application claims the benefit of U.S. Provisional Application No. 60/976,315, filed Sep. 28, 2007, which is incorporated herein by reference in its entirety.

### BACKGROUND

The application generally relates to the field of risk management. The application relates more specifically to the field of risk management systems for facilities (e.g., buildings).

The consequences for failing to maintain environmental requirements within a facility can be severe. Many facilities (e.g., manufacturing facilities, research and development facilities, processing facilities, food processing facilities, pharmaceutical production facilities, etc.) must maintain certain environmental requirements within one or more areas of the facility or the function of the facility (and/or that area within the facility) will fail. For example, some facilities or facility areas must maintain low humidity levels and positive pressure levels so that the introduction of bacteria into the area is minimized and so that bacteria growth is inhibited.

An improved system and method for understanding and quantifying business consequences or risk associated with the failure to maintain required environmental conditions within a facility is needed.

### SUMMARY

The invention relates to a method for evaluating risk associated with a facility and includes determining environmental requirements necessary for successful achievement of a function of the facility. The method further includes determining consequences for failing to maintain the environmental requirements. The method yet further includes identifying facility systems necessary to maintain the environmental requirements and calculating risk based on the identified facility systems and the determined consequences. The method yet further includes storing the risk in a memory device and/or displaying the risk on a display screen.

The invention further relates to a system for evaluating risk associated with a facility. The system includes an interface for receiving environmental requirements necessary for successful achievement of a function of a facility area. The system also includes an interface for receiving consequences for failing to maintain the environmental requirements. The system further includes an interface for receiving information used to identify facility systems necessary to maintain the environmental requirements. The system also includes a memory device for storing the environmental requirements and the consequences. The system further includes a processor configured to calculate risk based on the identified facility systems and the determined consequences, the processor further configured to store the risk once calculated. The interfaces comprise at least one of a user interface form, a data link to another system, and an interface to a database.

The invention further relates to an article of manufacture comprising a computer usable medium having computer readable code embodied therein for evaluating risk associated with a facility. The computer readable code includes computer code for receiving environmental requirements necessary for successful achievement of a function of a facility area. The computer readable code also includes computer code for receiving consequences for failing to maintain the environmental requirements. The computer readable code further includes computer code for identifying facility systems necessary to maintain the environmental requirements. The computer readable code also includes computer code for calculating risk based on the identified facility systems and the determined consequences. The computer readable code further includes computer code for storing the risk in a memory device.

The invention further relates to a system for transmitting computer readable code for evaluating risk associated with a facility. The system comprises a memory device for storing the computer readable code and a transmitter for transmitting the computer readable code. The computer readable code includes computer code for receiving environmental requirements necessary for successful achievement of a function of a facility area. The computer readable code also includes computer code for receiving consequences for failing to maintain the environmental requirements. The computer readable code further includes computer code for identifying facility systems necessary to maintain the environmental requirements. The computer readable code also includes computer code for calculating risk based on the identified facility systems and the determined consequences. The computer readable code further includes computer code for displaying the risk.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a facility having a plurality of facility systems, according to an exemplary embodiment;

FIG. 2 is a diagram of a system for evaluating business risk associated with a facility, according to an exemplary embodiment;

FIG. 3A is a flow chart of a process for evaluating risk associated with a facility, according to an exemplary embodiment;

FIG. 3B is a flow chart of a more detailed process for evaluating risk associated with a facility, according to an exemplary embodiment;

FIG. 4A is a data set associating a facility phase with an environmental requirement, according to an exemplary embodiment;

FIG. 4B is a data set for defining business consequences for failing to maintain environmental requirements, according to an exemplary embodiment;

FIG. 4C is a data set for identifying facility systems necessary to maintain environmental requirements, according to an exemplary embodiment;

FIG. 4D is a data set regarding component-level detail for a facility system, according to an exemplary embodiment;

FIG. 4E is a data set regarding a failure mode effect analysis (FMEA) that can be used with the method shown in FIG. 3B, according to an exemplary embodiment; and

FIG. 5 is a block diagram of a computer-based system for conducting and/or facilitating the various activities described herein, according to an exemplary embodiment.

### DETAILED DESCRIPTION

Before turning to the figures which illustrate the exemplary embodiments in detail, it should be understood that the application is not limited to the details or methodology set forth in the following description or illustrated in the figures. It should also be understood that the terminology employed herein is for the purpose of description only and should not be regarded as limiting.

Referring generally to the figures, a risk assessment method is shown and described. The method generally includes the steps of determining environmental requirements necessary for successful achievement of a function of the facility, determining consequences for failing to maintain the environmental requirements, identifying facility systems necessary to maintain the environmental requirements, and calculating risk based on the identified facility systems and the determined consequences. The result of the risk calculation can be a numerical value (such as expected business loss in monetary units over a time interval) for the risk of the facility function in question. The risk can be calculated based on determining the probability that the facility systems will fail. Probability of failure can be determined by building and using logic models of the systems (and in some embodiments the components that make up the systems) necessary for successful achievement of the function of the facility.

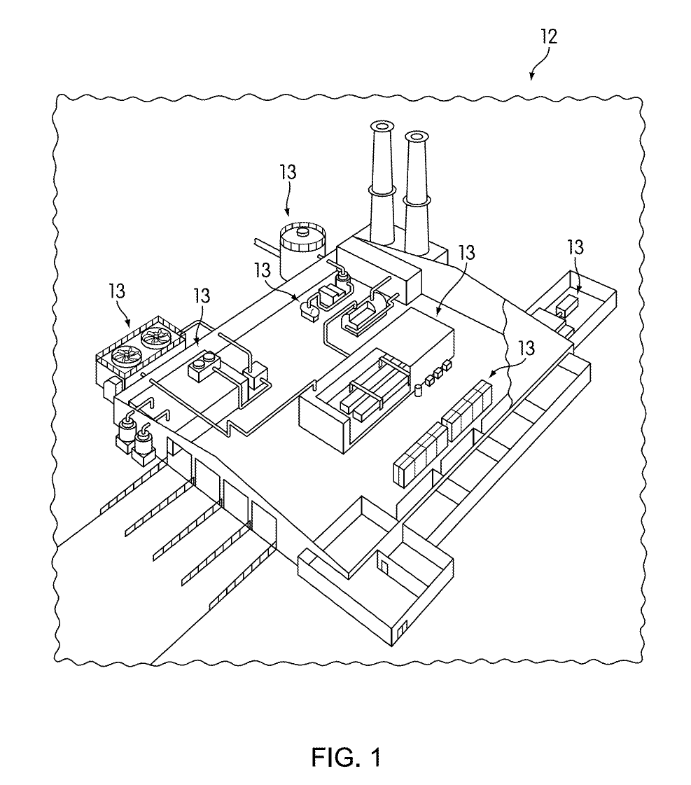

Referring now to FIG. 1, a perspective view of a facility 12 having a plurality of facility systems (e.g., equipment, devices, components) 13 is shown. As illustrated, facility 12 may include any number of facility areas (e.g., floors, rooms, zones, etc.). According to various exemplary embodiments, facility 12 may be any building and/or area of any size or type, including an outdoor area. Facility systems 13 may exist inside or outside of the facility, on or in the ceiling or floor, on walls, be user interactive or not, and may include any type of building management device, HVAC device, mechanical device, electrical device, electronic device, manufacturing device, processing device, security device, or other component for supporting the facility system or the facility. For example, facility systems 13 may be or include components such as a pump, a circuit breaker, a fan, a temperature sensor, an electronic controller, a damper, a control valve, an actuator, a humidity sensor, etc. Facility systems (and components) 13 may operate independently or interdependently to allow for achievement of facility functions (e.g., maintain humidity below a certain threshold, maintain temperature, maintain lighting levels, maintain pressure levels, etc.).

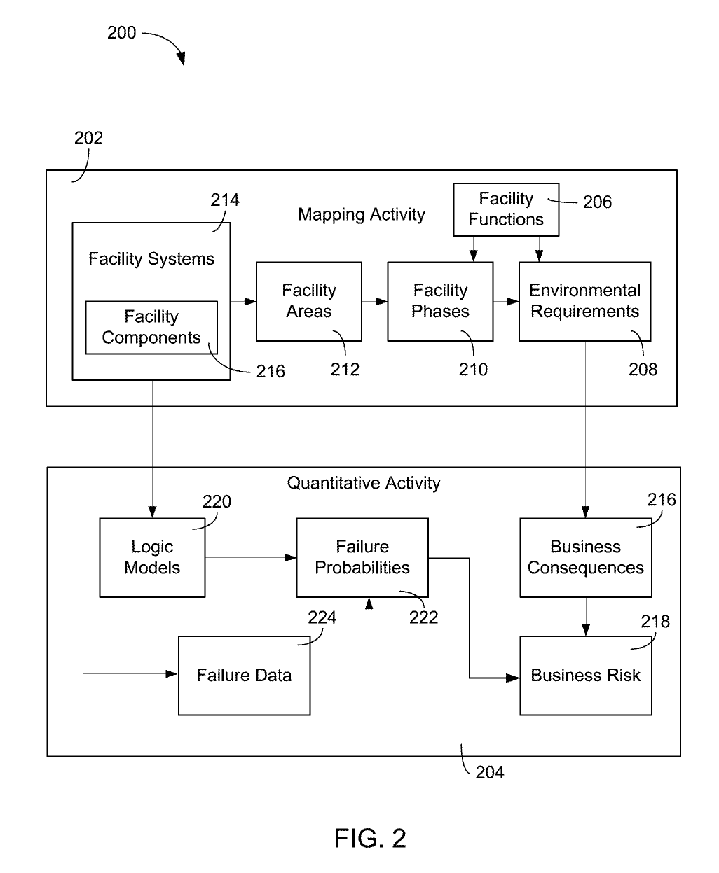

Referring now to FIG. 2, a diagram of a system 200 for evaluating business risk associated with a facility is shown, according to an exemplary embodiment. System 200 is shown to include mapping activity 202 and quantitative activity 204. Mapping activity 202 generates a number of inputs for quantitative activity 204. For example, mapping activity 202 results in the definition of inputs 206-216. Mapping activity 202 can be conducted via an automated, semi-automated, or manual process.

Mapping activity 202 begins with the assumption that facilities are built to establish and maintain environmental conditions for the business. Accordingly, to understand the risk associated with the facility, the inputs to establishing and maintaining the environmental requirements for the business are defined via mapping activity 202. Mapping activity 202 can be viewed as a methodology for engaging with facility owners or managers to fully define the facility. Mapping activity 202 can be conducted with the aid of computer-based tools or interfaces (e.g., graphical user interfaces, forms, databases, tables, web-interfaces, stand-alone interfaces, form “wizards”, etc.). Regardless of the method or methods of data entry, inputs 206-216 generated by the mapping activity can be stored in one or more computer memory devices and in any suitable data structure (e.g., relational database, one or more data tables, etc.).

Mapping activity 202 is shown to include facility functions 206, environmental requirements 208, facility phases 210, facility areas 212, facility systems 214, and facility components 216. Facility functions 206 is one or more basic descriptors of one or more functions (i.e., object, goal, mission success criteria, etc.) for the facility. For example, an object of the facility may be to produce at least 10,000 units of a product per week without any safety-affecting contaminations due to improper environmental conditions. Using facility functions 206 as a starting point for the mapping activity, a facilitator (e.g., a person, a survey, a computerized system, etc.) of the mapping activity can define environmental requirements 208 (e.g., the environmental requirements necessary to accomplish facility functions 206). For many types of facility functions involving processes having multiple steps, goals, or facility uses, the facility can be logically divided into a plurality of facility phases 210. For example, a production facility might have a first warehousing phase, a material preparation phase, a processing phase, a packaging phase, and a second warehousing phase. Each phase might have a different set of environmental requirements or other properties. Each phase may be associated with one or more physical (or logical) facility areas 212. For example, three large facility areas (e.g., rooms, zones, etc.) might be associated with a single material preparation phase. Even if few or no physical boundaries exist for defining areas, an area might be defined by places affected by different facility systems (e.g., a first facility area might be defined because it is lit by a first lighting group and a second facility area might be defined because it is lit by a second lighting group). Mapping activity 202 is further shown to include defining facility systems 214. Facility systems 214 are associated with facility areas 212 (or directly with facility phases 210, according to some exemplary embodiments). The information for associating facility systems 214 with facility areas 212 may be available via a building automation system or another data source. Depending on the level of granularity/complexity of the risk assessment activity desired, facility systems 214 may further be broken down into facility components 216 with one or more facility components associated with a single facility system.

With mapping activity 202 complete, and both (a) environmental requirements necessary for successful achievement of facility functions and (b) the facility systems that support the environmental requirements having been defined, quantitative activity 204 can advantageously be conducted to investigate the business risk 218 posed by the facility. The definitions of facility systems 214 and components 216 are used to define logic models 220. Logic models 220 are logical representations of how the various systems and components of a facility work together to achieve the environmental requirements for the areas/phases. Systems and components are linked together (e.g., one component's success may be linked to or depend on the success of another component's success) to the extent that their interaction is necessary to achieve the environmental requirements critical to facility functions. The resulting linked systems and components form the logic models that can subsequently be processed.

Using historical data, lifespan data, performance tests, visual inspection, and/or other information sources or techniques, failure data 224 for systems 214 and components 216 can be collected, calculated, or maintained. For example, failure data 224 can be provided by a building automation system database of sensor information, system/component alert information, and/or system/component status information.

Logic models 220 and failure data 224 are used to create failure probabilities 222. Probabilities 222 are the probabilities that the systems and/or components that relate to a phase or area will be unable to maintain the environmental requirements required for the phase.

Using environmental requirements 208 and an understanding of facility functions 206, facility phases 210, and/or facility areas 212, business consequences 216 can be defined. Consequences for failing to maintain environmental requirements 208 may be defined for each facility phase. Consequences of failure may be business results or costs (e.g., expressed in monetary, environmental, and/or social terms) of failing to maintain the determined environmental requirements for a phase. An example of a business consequence relating to facility performance is accounting cost accrued for a product that must be scrapped because of the inability to maintain the humidity of a production space within specification. Another example of a business consequence relating to facility performance is the opportunity cost of ongoing research that is nullified by failing to maintain the required environmental requirements for a related research phase. The activity of defining consequences 216 can be completed via interviews with individuals such as production, financial, or facility management staff. According to an exemplary embodiment, initial or ongoing business consequences 216 can be defined via computer based systems. For example, an accounting database and an inventory management database might provide inputs to an aggregator for business consequences 216.

The business risk 218 associated with the failure to meet the environmental requirements for a phase is calculated using failure probabilities 222 and business consequences 216, according to an exemplary embodiment. The calculation of risk for a phase may be as simple as a single multiplication of the consequence (e.g., in monetary units) or may be a more complex calculation based on additional variables. The calculation of failure probabilities 222 and business risk 218 can be conducted by one or more computer-based processes.

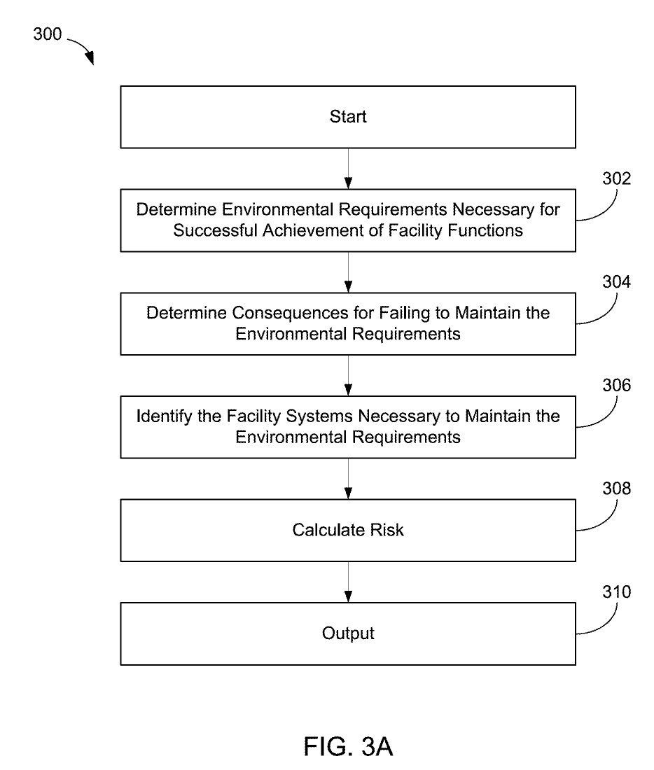

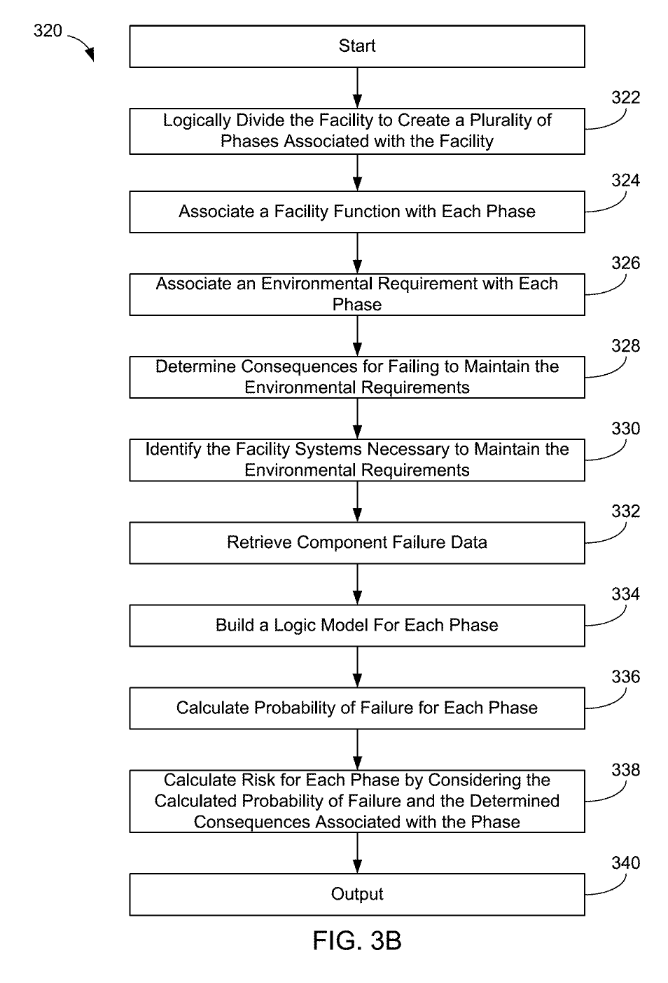

Referring now to FIG. 3A, a flow chart of a process 300 for evaluating risk associated with a facility is shown, according to an exemplary embodiment. Process 300 is shown to include determining environmental requirements necessary for successful achievement of a function of the facility (step 302). Process 300 is further shown to include determining consequences for failing to maintain the environmental requirements (step 304). Once environmental requirements are defined in step 302, process 300 includes the step of identifying the facility systems necessary to maintain the environmental requirements (step 306). Risk is then calculated (step 308) and an output of the risk (and/or information relating to the risk) is generated (step 310). According to an exemplary embodiment, steps 302 through 306 correspond to mapping activity 202 shown in FIG. 2 while step 308 corresponds to quantitative activity 204 shown in FIG. 2.

Referring now to FIG. 3B, a flow chart of a more detailed process 320 for evaluating risk associated with a facility is shown, according to an exemplary embodiment. Process 320 is shown to include logically dividing the facility to create a plurality of phases associated with the facility (step 322) and associating a facility function with each phase (324). For example, in step 322 the facility might be divided into five phases with each phase having at least one business function (e.g., raw material warehousing, initial preparation, coating, crimping, and packaging).

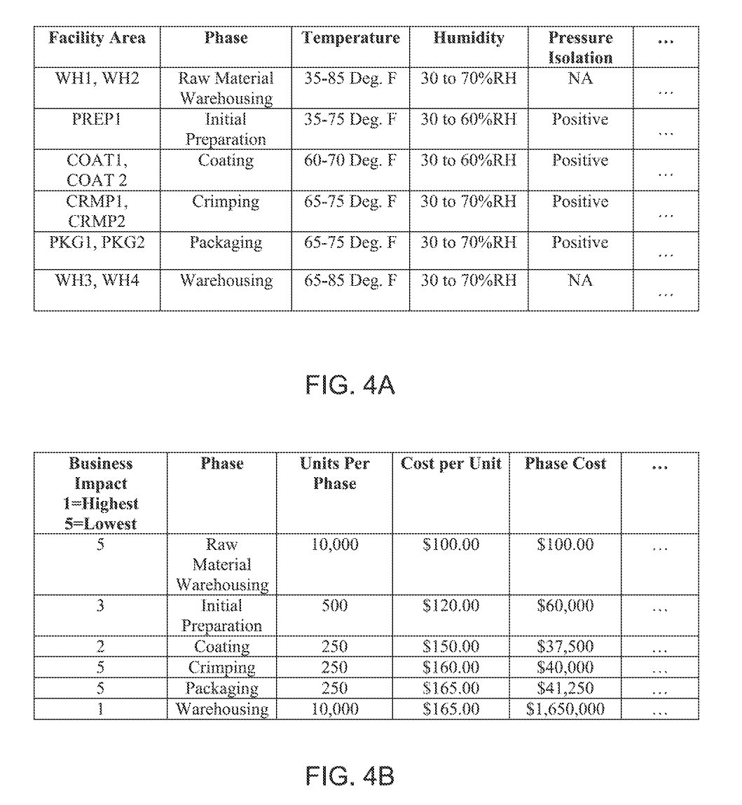

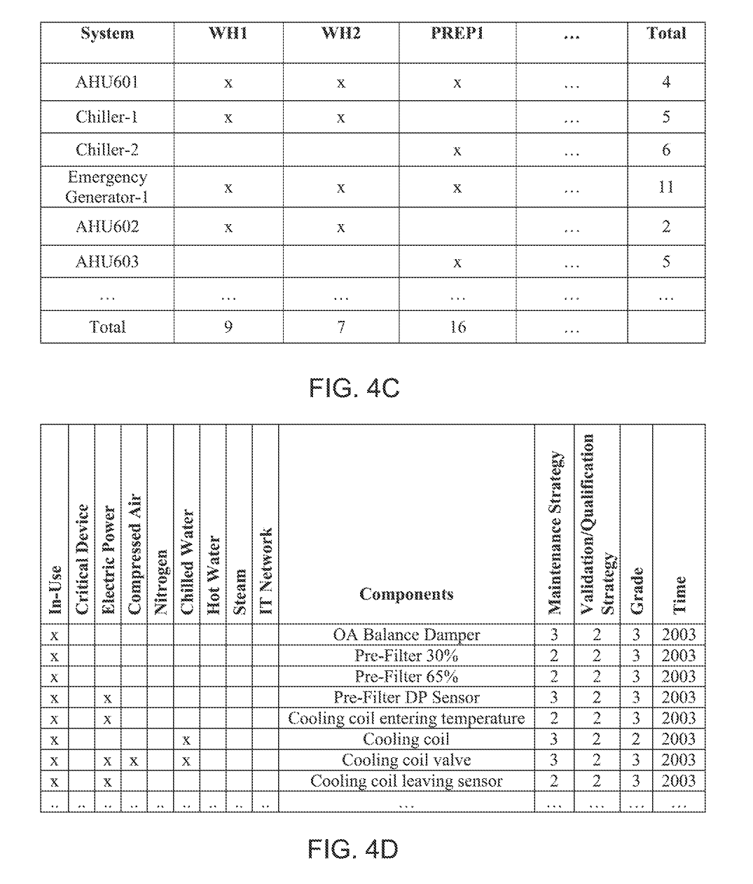

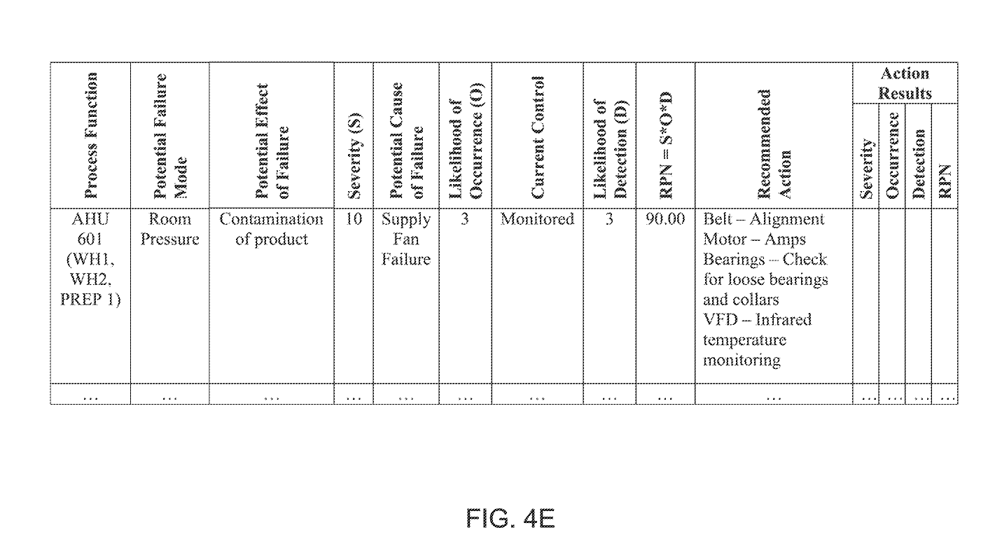

An environmental requirement is associated with each phase (step 326). The association of an environmental requirement with each phase can result in, for example, the data set shown in FIG. 4A. As shown in the exemplary data set of FIG. 4A, each phase is associated with the environmental requirements of a certain temperature range for the phase, a certain humidity range for the phase, and in some cases a pressure isolation requirement. It should be appreciated that any number or type of environmental requirements can be associated with the phases (e.g., lighting requirements, air quality requirements, outside air percentage, back-up power requirements, security requirements, and the like). As shown, environmental requirements can be in the form of boolean values or ranges, but may also be in the form of a setpoint, a setpoint plus and/or minus some deviation, a threshold, warning ranges, environmental recovery parameters (acceptable length of excursion before loss), or otherwise. As also illustrated in the exemplary data set of FIG. 4A, each phase is associated with one or more facility areas (e.g., the coating phase is associated with areas COAT1 and COAT2). It should be appreciated that the results of the associations of the steps of process 320 can be temporarily and/or permanently stored in data structures other than those shown in FIGS. 4A-4C (e.g., relational databases, spreadsheets, tables, flat text files, complex data structures, XML files, etc.).

Process 320 is then shown to include defining consequences for failing to maintain environmental requirements (step 328). The step of defining consequences for failing to maintain environmental requirements can result in, for example, the data set shown in FIG. 4B. The illustration of FIG. 4B shows each phase associated with a number of metrics for quantifying business consequences for failing to maintain the environmental requirements of a phase (e.g., units per phase, cost per unit, phase cost). 4B also illustrates that a definition of a business consequences for a phase can be a ranking (e.g., business impact) rather than (or in addition to) detailed quantifications. It should be appreciated that a number of different metrics for quantifying business risk can be determined and associated with each phase (e.g., lots/phase, unit quantity/lot, units per phase, yield %, cost/unit, lot cost, production phase cost, unit market value, production phase market value, etc.).

Process 320 is further shown to include the step of identifying the facility systems necessary to maintain the environmental requirements (step 330). The step of identifying facility systems necessary to maintain the environmental requirements can result in, for example, the data set shown in FIG. 4C. The illustration of FIG. 4C shows the spaces (i.e., areas, phases) of the facility associated with one or more systems (e.g., AHU601, Chiller-1, etc.). The rightmost column titled “Total” can show a count of the number of spaces served by a system. This count can be used as a rough measure of system risk (the more spaces a system serves, the greater the risk of its failure). By processing a data set such as the set shown in FIG. 4C, the consequences of a single system failing can be quickly estimated. For example, if the system named “AHU603” were to fail, the corresponding total in the rightmost column indicates that five spaces would be exposed to AHU603's failure. The bottom row titled “Total” can show a count of the number of systems serving any particular space and is a measure of complexity for the space. This row can indicate the importance of considering system interactions when evaluating risk. Further, it might be assumed that a space with high complexity has a greater probability of failure than a space with low complexity. For example, the space named “PREP1” is shown to be served by sixteen systems and might be assumed to have a greater probability of failure than less complex spaces. A consequences row could be added to the data set shown in FIG. 4C to help capture consequences (i.e., to associate consequences with the failure to maintain the environmental requirements of a space). A risk column (or row) could then also be added to the data set shown in FIG. 4C. For example, the risk column (or row) could be configured to apply a weighted average function of the space consequences, the complexity, or other metrics to provide an indication of risk.

As data is collected regarding the systems and the risk posed to the success or failure of a facility function by a system is understood, one or more of the systems can be further divided into one or more components, as shown in FIG. 4D. For example, AHU603 may be determined to be a high risk system so the system (or a human user) can initiate the gathering of the data shown in FIG. 4D. According to an exemplary embodiment, component information is gathered for every critical system in a facility. The “components” column shown in FIG. 4D can list each component of the system while the grid to the left of the “components” column can detail ways in which the component is used or other component properties. As also illustrated by FIG. 4D, the time in service of each component can be tracked, a current maintenance strategy for the component can be tracked, a validation qualification strategy for the component can be tracked, and a grade for the component can be tracked.

Referring back to FIG. 3B, process 320 is also shown to include retrieving component failure data (step 332). Retrieving component failure data may be accomplished in a number of different ways. In some embodiments, facility manager interviews will be used to populate one or more variables to track, for example, the number of times each system (and/or component) has failed over the past year. In other embodiments, historical information from a log book, an electronic database, and/or a building automation system may be retrieved to gather, compile, and/or understand component failure. According to yet other exemplary embodiments, graphs, charts, or the underlying data thereof can be analyzed to help predict the probability of future component failure.

Using system (and in some embodiments, component) definitions for a phase, a logic model for each phase can then be built (step 334). The logic model can be in the form of a fault tree, a reliability block diagram, a predetermined mathematical formula, or any other system dependency model that can logically describe the interrelationships between systems (and/or components thereof). Using the logic models and the failure data, the system can calculate a probability of failure for each phase (step 336). It is important to note that probabilities of failure can be calculated using data other than complete logic models and actual failure data. For example, probabilities of failure could be estimated using mean time to failure information coupled with system age, historical failure information for similar facilities, system contribution counts (i.e., how many phases/areas are served by any one system), phase complexity counts (i.e., how many systems each phase/area depends upon), and the like. Because the systems are logically modeled (i.e., linked) via defined logic models and a probability calculation can use the logic models and system failure data to determine system failure probability, the resulting tool (the set of logic models, failure data, and a calculation activity) can be used by the system or the user to simulate or test the effects of system changes. For example, a user might insert a back-up generator into a logic model (e.g., fault tree) to view how the insertion of the back-up generator affects the probability of higher level system failure, phase failure, or business consequences. A graphical user interface can be provided to the user for allowing the user to graphically insert systems/components into logic models (e.g., fault trees).

According to an exemplary embodiment, and referring still to FIG. 3B, risk is calculated for each phase by considering the calculated probability of failure and the determined consequences (step 338). Risk may be calculated by multiplying probability of failure for a phase or system by an estimated consequence. According to an exemplary embodiment, risk is quantified in terms of monetary units per year (e.g., $/yr) with the inputs to the probability times consequence function being consequences in monetary units and a probability of failure during a year (probability/yr). Risk expressed quantitatively in monetary units over time allows a clear analysis of risk reduction benefits versus cost for decisions regarding operations, maintenance, and capital spending. A process for evaluating business decisions using the methodology described in this application can be used to evaluate future business decisions. The basic process includes the steps of: (a) identifying the proposed change and the cost to implement; (b) modifying the logic model (e.g., risk model, fault tree, etc.) to incorporate the change; (c) calculating the reduction in risk (e.g., in $/yr) provided by the change; (d) identifying other benefits (e.g., an energy cost reduction); and (e) comparing the cost and benefits. Using such a process, the methodology and tools described herein can be used over the entirety of the facility life cycle, from design, to operation and maintenance, to modifying (i.e., significantly changing the facility or the use for the facility). Designing for risk using the methodology described herein allows the establishment of a baseline risk for the design, allows a user to perform a cost-benefit analysis of design options, and allows the evaluation of a risk-based regulatory compliance stance. When used for continuous risk management, the methodology described in the present application allows a risk-based maintenance strategy (e.g., targeting those phases and systems that present the greatest business risk) and/or allows a near-real time “risk meter.” When used for modifying the facility or for evaluating risk-based investments, the methodology allows the prioritization of capital projects based on risk impact and allows risk benefits (reductions in risk) to be included in a project's financial analysis.

Risk can be output at step 340. The output of risk can include one or more activities to store the calculation of risk, to generate a graphical representation of the calculation of risk for display on an electronic display device, to print the risk via a report, or otherwise. Output of risk can be or include a ranking or list of risks for the different phases and/or spaces of a facility. By ranking risk, a facility manager might easily spot the areas which to focus on for maintenance or upgrading purposes.

According to various exemplary embodiments, risk determined using the above-described processes can be compared and/or supplemented by other risk calculation methodologies. For example, development of the logic models and failure probabilities can include Failure Modes and Effects Analyses (FMEA) for the spaces, systems, and components determined to pose the highest risk through the mapping process. Using a data structure or table as shown in FIG. 4E, the system and/or a user thereof can recommend actions for reducing system probability of failure (and therefore risk), and track the results of any recommended actions.

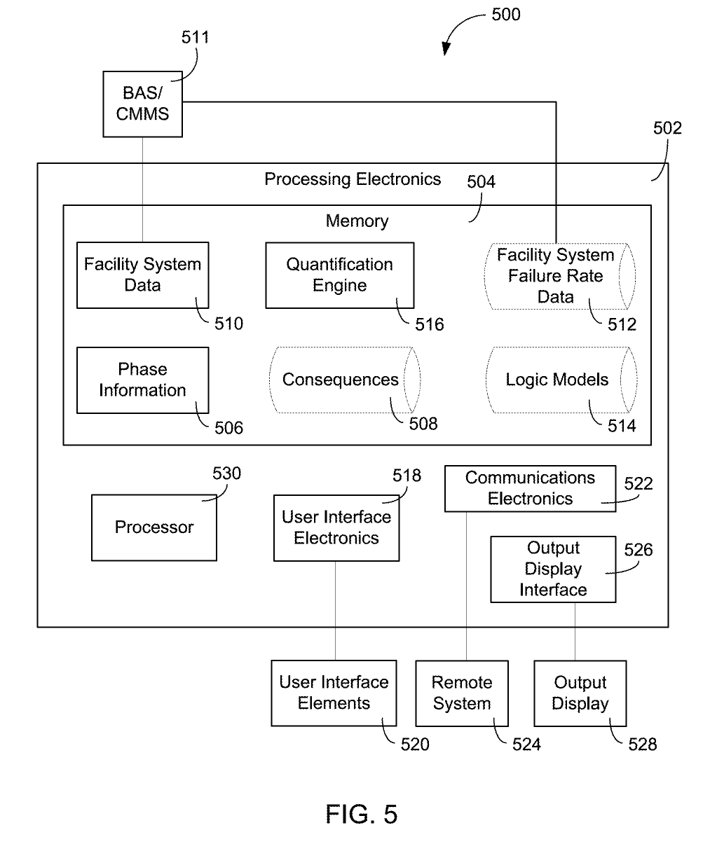

Referring now to FIG. 5, a computer-based system 500 for conducting and/or facilitating the various activities described herein is shown. Computer-based system 500 is shown to include processing electronics 502 having memory 504 and processor 530. Processing electronics 502 can be integrated into another controller or system (e.g., a BAS controller, a general purpose computer, an accounting system, etc.), can be part of a special purpose machine, a stand-alone computer, a distributed computing system, or otherwise. Memory 504 is shown to include a plurality of data sets, engines, or modules 506-514 that can generally be or include data structures, data sets, executable computer code modules, scripts, object code, or other items stored in memory that can be accessed by processor 530 for execution, retrieval, and/or other processing activities. Phase information 506 can be one or more files, tables, spreadsheets, or other data structures for storing the definitions of the phases for a facility. Consequences 508 can be one or more files, tables, spreadsheets, or other data structures for storing consequences and/or for associating consequences with the failure to maintain environmental requirements for the phases/spaces of the facility. Facility system data 510 can be an item tree, a list, or another data structure of the systems (and components) that provide environmental control to a facility phase/area. As shown, facility system data 510 and/or facility system failure rate data 512 can include an interface for receive an input (e.g., an initial input, an update, etc.) from a BAS, a computerized maintenance management system (CMMS) or another system 511. For example, facility drawings (e.g., CAD), BAS interconnection data, GPS data, and/or other stored or derived data can be used for entry into the system at facility system data 510 or facility system failure rate data 512. Logic models 514 can be created based on facility system data 510, facility system failure rate data 512, phase information 506, consequences 508 or via another system or method. For example, logic models 514 can be manually built via one or more off the shelf modeling packages. According to various exemplary embodiments, the logic models can be fault trees or reliability block diagram (RBDs).

System 500 is further shown to include quantification engine 516. Quantification engine 516 may generally be one or more functions, classes, or computer code modules for conducting probability of failure (or success) calculations, for generating the logic models, for calculating risk, and/or for conducting or facilitating any of the other processing activities described herein. According to an exemplary embodiment, quantification engine 516 receives logic model information from logic models 514 and determines a probability of “mission failure” using the combination of logic models 514 and facility system failure rate data 512. Quantification engine 516 may receive and use several inputs, according to various exemplary embodiments. For example, quantification engine 516 can receive information regarding different components of a system from any of modules 506-514 or from any other source.

Quantification engine 516 can generate output (e.g., an output of an indication of risk). Outputs from the engine 516 may be stored in memory 504, stored in another memory device, transmitted to a remote system 524 using communications electronics 522 (wired or wireless communications electronics), provided to an output display 528 via output display interface 526, included in a spreadsheet for printing or e-mailing, or otherwise. For example, quantification engine 516 can provide a probability report to a user, the probability report providing an indication of mission failure or success probability based on the current system configurations, phase success/failure probabilities, system success/failure probabilities, and/or any number of related probabilities or data. Quantification engine 516 can also provide a user with a risk report regarding business costs risks, opportunity costs risks, maintenance costs risks, repair costs risks, environmental costs risks, social costs risks, and/or any other risk values determined by the quantification engine and relating to calculated probabilities of success/failure and business consequences.

User interface electronics 518 can be configured to receive and process inputs received from user interface elements 520 (e.g., a keyboard, a mouse, a touch screen, etc.). User interface electronics 518 and user interface elements 520 provide users with a mechanism for entering data into one or more of modules 506-514 or for interacting with any of the other components of system 500. For example, user interface electronics 518 and user interface elements 520 can allow a user to build logic models based on a graphical user interface. Output display interface 526 may be configured to provide one or more user interface forms via output display 528, the forms for prompting a user for input regarding the definitions and associations of the system. The forms can be or include tables, spreadsheets, dialog boxes, or any other graphical user interface forms or element. Input to the forms can be received via user interface elements 520.

With reference to FIG. 5, it should be noted that any of a variety of technologies can be used to implement processing electronics 502, memory 504, processor 530, and electronics 518, 522, 526. For example, processor 530 can be a general purpose processor (e.g., an Intel Centrino processor), an application specific integrated circuit (ASIC), a field programmable gate array (FPGA), multiple processors, distributed processors, or any other type of processor. Memory 504 can be any type of volatile and/or non-volatile memory device including, but not limited to, RAM, ROM, DRAM, DDR memory, flash memory, solid state memory, portable storage medium, a distributed storage system, hard disk memory, or any other suitable type of memory.

Referring still to FIG. 5, it should be noted that a computer-based implementation of processing circuit 500 can be used to generate and/or provide a feature such as a “risk meter.” The risk meter allows facility operators to quantify the risk impact of taking equipment out of service for maintenance or if equipment is down for repair, in near real time. The risk meter can be or include a report or a graphical user interface that a user or the system is able to update (e.g., on-demand, on a regular interval, etc.) to view how “live” changes in the facility and/or in the phase inputs are affecting risk/business consequences posed by the facility. For example, an accounting system may provide raw materials costs to the system and fluctuations in raw materials costs could automatically update the business consequences for failing to maintain the environmental requirements that could affect the raw materials. An updated “risk meter” could show that risk has exceeded a threshold level and explain the reason for such an increase. By way of further example, as equipment ages or time elapses since the last service inspection or maintenance activity, failure risk of the component could also be modeled to increase in a linear or non-linear fashion. Each day (or week, quarter, month, year, etc.) the system could automatically update, taking into account these metrics and updating the probabilities of failure and subsequently the final risk calculations/outputs. In other words, any of the determining steps of the flow charts or the information/data sets of the Figures can be updated in real-time or near real-time according to various exemplary embodiments. The system can then conduct one or more recalculations and update a report, graphical user interface, storage location, or display electronics to provide an automatically updating “risk meter.”

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

The present application contemplates methods, systems and program products on any machine-readable media for accomplishing its operations. The embodiments of the present application may be implemented using existing computer processors, or by a special purpose computer processor for an appropriate system, incorporated for this or another purpose or by a hardwired system.

The construction and arrangement of the risk assessment method as shown in the various exemplary embodiments is illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter. For example, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. Other substitutions, modifications, changes and omissions may be made in the design, operating conditions and arrangement of the exemplary embodiments without departing from the scope of the present application.

As noted above, embodiments within the scope of the present application include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can include RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

It should be noted that although the figures herein may show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the application. Likewise, software implementations could be accomplished with standard programming techniques with rule based logic and other logic to accomplish the various connection steps, processing steps, comparison steps and decision steps.

What is claimed is:

1. A method for evaluating risk associated with a facility, the method comprising:
determining environmental requirements necessary for successful achievement of a function of the facility;
determining consequences for failing to maintain the environmental requirements;
identifying facility systems necessary to maintain the environmental requirements;
calculating risk based on the identified facility systems and the determined consequences; and
storing the risk in a memory device and/or displaying the risk on a display screen.

2. The method of claim 1, further comprising:
generating and displaying recommendations for facility system maintenance and/or redundancy based on the calculated risk.

3. The method of claim 1, wherein determining the environmental requirements necessary for successful achievement of a function of the facility comprises:
logically dividing the facility to create a plurality of phases associated with the facility;
associating a facility function with each phase; and
associating one or more environmental requirements with each phase, the environmental requirements necessary for successful achievement of the facility function for the phase.

4. The method of claim 3, wherein determining the consequences for failing to maintain the environmental requirements comprises creating a consequence matrix wherein each phase is associated with a consequence.

5. The method of claim 3, wherein determining the consequences for failing to maintain the environmental requirements comprises at least one of:
(a) determining a cost of the goods that would be lost if the environmental requirements were not maintained,
(b) determining a market value of the goods that would be lost if the environmental requirements were not maintained,
(c) determining a value for lost time if the environmental requirements were not maintained,
(d) estimating impact to revenue due to reputational damage if the environmental requirements were not maintained,
(e) estimating social costs,
(f) estimating environmental costs, and
(g) determining the total business cost in monetary units.

6. The method of claim 3, wherein determining the consequences for failing to maintain the environmental requirements comprises ranking the impact to business if the successful achievement of the function for each phase were not met.

7. The method of claim 6, further comprising:
counting the facility systems necessary to maintain the environmental requirements of each phase;
wherein calculating risk comprises evaluating the ranking of the impact to the business relative to the number of facility systems necessary to maintain the environmental requirements.

8. The method of claim 3, further comprising:
building a logic model for each phase based on the interdependencies of the facility systems serving each phase;
calculating a probability that the facility systems serving each phase will fail to achieve the environmental requirements for the phase based on the logic models;
wherein risk is calculated for each phase and wherein calculating the risk comprises multiplying the consequences for failing to achieve the facility function, in terms of monetary units, by the probability the facility systems serving each phase will fail over a period of time;
wherein the risk is expressed in terms of monetary units over time and wherein the method further comprises the step of ranking the phases by their impact on risk.

9. The method of claim 1, wherein determining the environmental requirements necessary for successful achievement of a function of the facility comprises:
logically dividing the facility to identify a plurality of areas within the facility;
associating a facility function with each area; and
associating one or more environmental requirements with each area, the environmental requirements necessary for successful achievement of the facility function for the area.

10. The method of claim 9, further comprising:
associating one or more of the areas with a phase in a manufacturing, research, or business process.

11. The method of claim 10, wherein determining consequences for failing to maintain the environmental requirements comprises determining the financial consequences for losing at least one of the inputs and outputs of the phase.

12. The method of claim 11, further comprising:
estimating the probability of failure for each facility system necessary to maintain the environmental requirements of each area.

13. The method of claim 12, wherein calculating the risk comprises assigning a risk priority ranking to each area based on the probability of failure of the systems of the area and based on the consequences for failing to maintain the environmental requirement for the area.

14. The method of claim 12, wherein calculating the risk comprises multiplying the consequence for each area by the probability of failure of the systems of the area.

15. The method of claim 12, further comprising:
receiving one or more inputs regarding the operational status of the systems of the area;
updating the probability of failure and the risk calculation based on the received one or more inputs; and
displaying the updated risk.

16. The method of claim 15, wherein the one or more inputs are received from a building automation system controller.

17. The method of claim 16, wherein the facility systems comprise at least one of:
a pump, a circuit breaker, a fan, a temperature sensor, an electronic controller for a building device, a damper, an actuator for a building device, a humidity sensor, an air handling unit, a chiller, a boiler, and a lighting system.

18. A system for evaluating risk associated with a facility, the system comprising:
an interface for receiving environmental requirements necessary for successful achievement of a function of a facility area;
an interface for receiving consequences for failing to maintain the environmental requirements;
an interface for receiving information used to identify facility systems necessary to maintain the environmental requirements;
a memory device for storing the environmental requirements and the consequences; and
a processor configured to calculate risk based on the identified facility systems and the determined consequences, the processor further configured to store the risk once calculated;
wherein the interfaces comprise at least one of a user interface, a data link to another system, and an interface to a database.

19. An article of manufacture comprising:
a computer usable medium having computer readable code embodied therein for evaluating risk associated with a facility, the computer readable code comprising:
computer code for receiving environmental requirements necessary for successful achievement of a function of a facility area;
computer code for receiving consequences for failing to maintain the environmental requirements;
computer code for identifying facility systems necessary to maintain the environmental requirements;
computer code for calculating risk based on the identified facility systems and the determined consequences; and
computer code for storing the risk in a memory device.

20. A system for transmitting computer readable code for evaluating risk associated with a facility, the system comprising:
a memory device for storing the computer readable code;
a transmitter for transmitting the computer readable code, wherein the computer readable code comprises:
computer code for receiving environmental requirements necessary for successful achievement of a function of a facility area;
computer code for receiving consequences for failing to maintain the environmental requirements;
computer code for identifying facility systems necessary to maintain the environmental requirements;
computer code for calculating risk based on the identified facility systems and the determined consequences; and
computer code for displaying the risk.
